(19) United States
(12) Patent Application Publication
(10) Pub. No.: US 2010/0191591 A1
(43) Pub. Date: Jul. 29, 2010

(54) METHOD AND SYSTEM FOR CONDUCTING A PARTICIPATION AWARD BASED AUCTION

(76) Inventor: Barry E. Silbert, New York, NY (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/693,927

(22) Filed: Jan. 26, 2010

Related U.S. Application Data
(60) Provisional application No. 61/147,374, filed on Jan. 26, 2009.

(51) Int. Cl. G06Q 30/00

(52) U.S. Cl. 705/14.23

(57) ABSTRACT

A method and system of conducting a participation award auction is provided. In a participation award based auction, a portion of a winning bid is distributed among one or more of the bidders engaged in the auction. A seller utilizing a participation award based auction may define the portion of the winning bid distributed among the bidders as well as the rules used to determine which bidders receive a portion of the winning bid. Providing bidders the opportunity to share in a portion of a winning bid may stimulate interest in a given auction and as a result increase the winning bid received by the seller.

### CROSS-REFERENCE TO RELATED APPLICATION

This application claims the benefit of U.S. Provisional Patent Application No. 61/147,374, filed Jan. 26, 2009, titled “System and Method for Facilitating a Participation Fee Auction,” which is herein incorporated by reference.

### FIELD OF THE INVENTION

The present invention relates generally to a method and system for conducting an auction. More specifically, embodiments of the present invention relate to a method and system for conducting an auction wherein the portion of the winning bid is distributed to one or more of the bidders.

### BACKGROUND OF THE INVENTION

Auctions provide an environment in which sellers can bring a product to market without establishing a fixed sale price. Within an auction environment, sellers rely on bids from a plurality of potential buyers to set the purchase price. Given that the purchase price is based on bids from a plurality of potential buyers (i.e., bidders), the seller has an incentive to increase the number of bidders interested in a given product.

Sellers utilizing conventional auction environments generate interest in a product much in the way interest is generated for a product within a fixed price marketplace. For example, sellers generate interest in a product by distinguishing themselves from competitors on price, quality, or service. However, unlike a fixed price marketplace, sellers in an auction environment have an increased incentive to generate interest in a product from a plurality of bidders in their product because such interest could result in a higher purchase price.

Despite the need to generate interest for a given product within an auction environment, conventional auction environments lack an effective means of incentivizing bidders to actively bid on an item up for auction. Conventional auction environments fail to reward bidders for their engagement in an auction (i.e., the act of placing bids, including non-winning bids) and as a result lack an effective mechanism for generating sufficient involvement from bidders within an auction environment. Therefore, sellers often fail to realize a maximum purchase price for a given product sold by auction.

As a result, there is a need in the art for a method and system to incentivize potential buyers to place bids for a product being sold in an auction and further reward a bidder for his or her continued and/or active engagement in the bidding process.

### SUMMARY OF THE INVENTION

Embodiments of the present invention satisfy these needs and others by providing a method and system configured to conduct an auction that compensates one or more bidders for placing a bid. According to certain embodiments of the present invention, a portion of the winning bid for an auction is allocated to one or more of the parties bidding on the auction. A seller utilizes embodiments of the present invention to sell a product, financial instrument, or and goods or services via an auction and can define the amount of or portion the winning bid (i.e., the final sale price) that is allocated among one or more of the bidders. Advantageously, providing one or more bidders with a portion of a winning bid increases interest in the auction and in turn optimizes the final sale price associated with the auction.

According to an embodiment of the present invention, a seller may define a plurality of auction parameters governing an initialized auction. The auction parameters may include, but are not limited to, a subject (i.e., the goods and/or services being offered) of the auction, a duration of the auction, a bid increment, a reserve price, a participation rule, and a participation award parameter. The term “participation rule” is intended to include, but is not limited to, the criterion used when determining and identifying which bidders engaging in a given auction are entitled to receive a portion of the winning bid (i.e., participating bidders). For example, a participation rule may dictate that bidders who placed the five highest non-winning bids are considered participating bidders. Alternatively, the participation rule may provide that all bidders who placed bids within 2% of the winning bid are considered participating bidders. The term “participating bidder” is intended to include, but is not limited to, a party who places a bid in a given auction that entitles the party to receive a portion of the winning bid upon completion of the auction, in accordance with an embodiment of the present invention. According to certain embodiments of the present invention, a participation rule may dictate that the winning bidder be considered a participating bidder.

In addition to a participation rule, the auction parameters may also include a participation award parameter. The term “participation award” is intended to include, but is not limited to, the portion of the winning bid that is distributed to the one or more participating bidders. The participation award parameter is used to calculate the participation award, which is allocated to the participating bidders upon completion of the auction. According to an embodiment of the present invention, the participation award parameter may be defined in terms of a percentage of the winning bid. For example, a seller may initiate an auction wherein the participation award parameter is 5% of the winning bid. As a result, if the winning bid is $100,000, the participation award is $5,000, and is distributed among the participating bidders according to the applicable participation rule. In an alternative embodiment of the present invention, the participation award parameter may be a fixed dollar amount, a graduated percentage calculation, or other distribution scheme.

Once a seller has initiated an auction, a plurality of bidders may place bids with respect to the auction. As new bids arrive, embodiments of the present invention manage the auction by updating the current highest bid and determining the participation status of the bidders according to the participation rule. The term “participation status” is intended to include, but is not limited to, a determination of whether a bidder is a participating bidder, non-participating bidder, or holds the highest bid. The participation status of a bidder may change based on the arrival of new bids. Upon the close of an auction, embodiments of the present invention facilitates the collection of the winning bid, allocation of the participation award to the participating bidders and any fees associated with conducted the auction, and distribution of the remaining portion of the winning bid to the seller.

An embodiment of the present invention provides for a method of allocating a portion of a winning bid for an auction to one or more participating bidders, comprising the steps of: receiving a request to initialize an auction, wherein the request comprises a plurality of auction parameters comprises a participation award parameter and a participation rule, initializing an auction based on the request, receiving one or more bids from a plurality of bidders, determining the one or more participating bidders from the plurality of bidders based on the participation rule, establishing a winning bid based on the plurality of bids, calculating a participation award based on the participation award parameter and the winning bid, and allocating at least a portion of the participation award to the one or more participating bidders.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary system for conducting a participation award based auction, according to an embodiment of the present invention;

FIG. 2 illustrates an exemplary method for facilitating a participation award based auction, according to an embodiment of the present invention;

FIG. 3 illustrates an exemplary interface for creation of a participation award based auction; according to an embodiment of the present invention; and

FIG. 4 illustrates an exemplary notification provided to a bidder, according to an embodiment of the present invention.

### DETAILED DESCRIPTION OF THE DRAWINGS

The present invention relates to a method and system for conducting a participation award based auction. According to certain embodiments of the present invention, a seller initializes an auction wherein a portion of the winning bid is allocated and distributed to one or more of the bidders who placed bids in the auction. As a result, bidders have a monetary incentive to place bids in the auction (i.e., become engaged), which increases bidding activity and drives up the winning bid for the auction. Embodiments of the present invention allow a seller to define the rules used when establishing which bidders receive a portion of the winning bidder. Furthermore, embodiments of the present invention allow the seller to determine the portion of the winning bid that is distributed among such bidders.

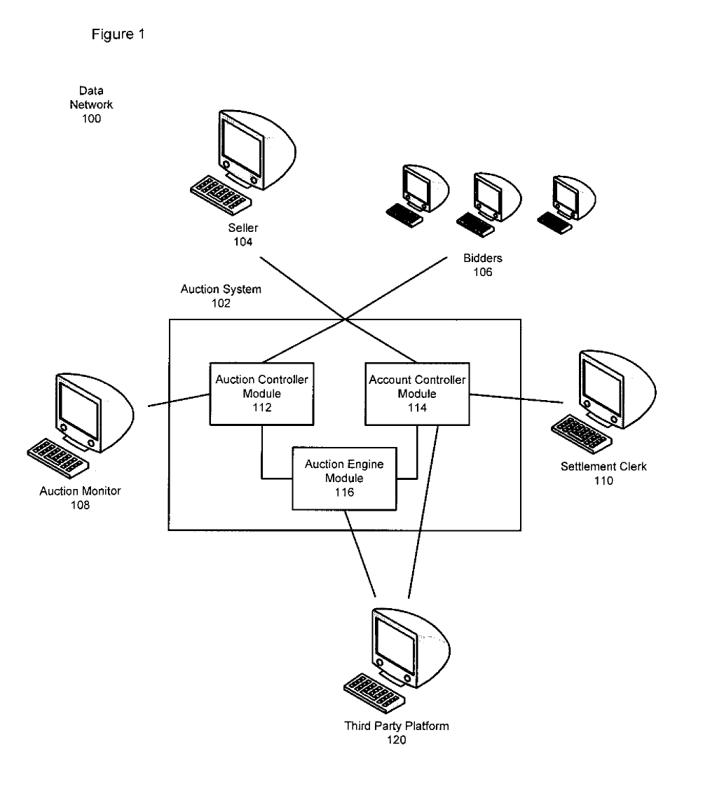

FIG. 1 illustrates a Data. Network 100 according to an embodiment of the present invention. As illustrated in FIG. 1, the Data Network 100 includes an Auction System 102, a Seller 104, a plurality of Bidders 106, an Auction Monitor 108, a Settlement Module 110, and a Third Party Platform 120. As illustrated in FIG. 1, according to an embodiment of the present invention, the Auction System 102 comprises an Auction Controller Module 112, an Auction Settlement Module 114, an Auction Engine Module 116, and a Database 118. As used herein, the term “module” is intended to include, but is not limited to, one or more computers configured to execute one or more software programs configured to perform one or more functions. The term “computer” is intended to include any data processing device, such as a desktop computer, a laptop computer, a mainframe computer, a personal digital assistant, a server, a handheld device, or any other device able to process data. The aforementioned components of the Data. Network 100 and the Auction System 102 represent computer hardware and/or computer-implemented software modules configured to perform the functions described in detail below. One having ordinary skill in the art will appreciate that the components of the Data Network 100 may be implemented on one or more communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers.

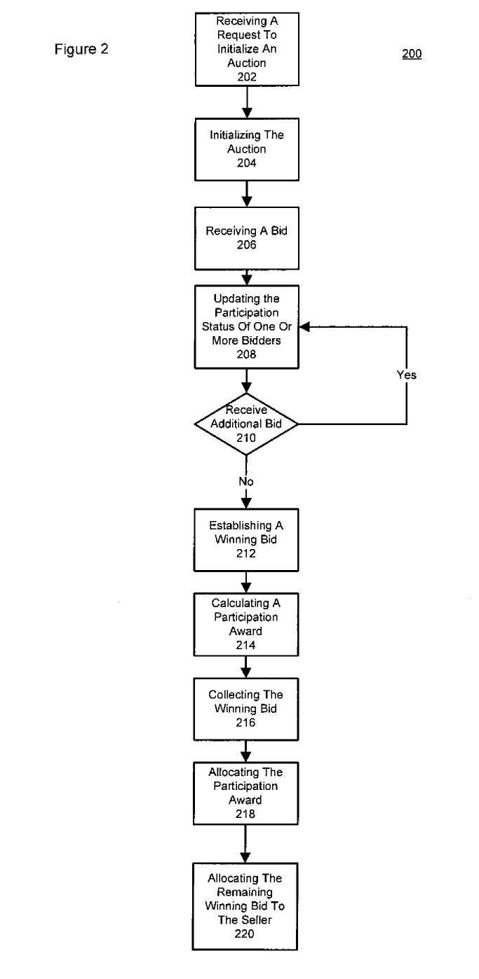

The features and functionality of embodiments of the Data Network 100 and its components are described in detail in connection with the system diagram of FIG. 1 and the process flow diagram of FIG. 2. As illustrated in FIG. 1, the Seller 104 is communicatively connected to the Auction System 102. In operation, the Seller 104 provides a request to initialize an auction to the Auction System 102, at step 202 in FIG. 2. More specifically, according to the embodiment of the present invention illustrated in FIG. 1, the request to initialize an auction may be received by the Auction Controller Module 112, within the Auction System 102. The Auction Controller Module 112 is configured to receive a request from the Seller 104 to initialize an auction. The request includes a plurality of auction parameters defining the terms of the auction. The auction parameters may include, but are not limited to, a subject of the auction, a duration of the auction, a bid increment, a reserve price, a participation award, and a participation rule. The subject of the auction may be any product and/or service which the Seller 104 wishes to transfer, and may include any tangible property or intangible property. According to certain embodiments of the present invention, the subject may be a stock, bond, warrant, or other type of financial instrument. For example, the subject of an auction is a financial instrument, the subject of the auction may be defined as 1,000 shares of common stock in ABC Corp. In this example, a reserve price and a bid increment may be expressed in reference to a single share of the ABC Corp. stock or based on the entire bundle of shares.

The auction parameters include a participation award parameter and a participation rule. As describe above, the participation award defines the portion of the winning bid that will be distributed to the one or more participating bidders. Furthermore, the participation rule dictates which bidder or bidders are verified to be participating bidders.

According to certain embodiments of the present invention wherein the subject of the auction is a divisible bundle of goods, such as, for example, shares of stock, the Seller 104 may allow a Bidder 106 to bid on only a portion of the entire bundle. In such an embodiment, one of the auction parameter may identify if the auction is an “All or Nothing” auction, wherein the Bidder 106 must purchase the entire bundle. Alternatively, the Seller 104 may establish that the bundle is divisible and may define a minimum amount of goods for which a Bidder 106 may place a bid.

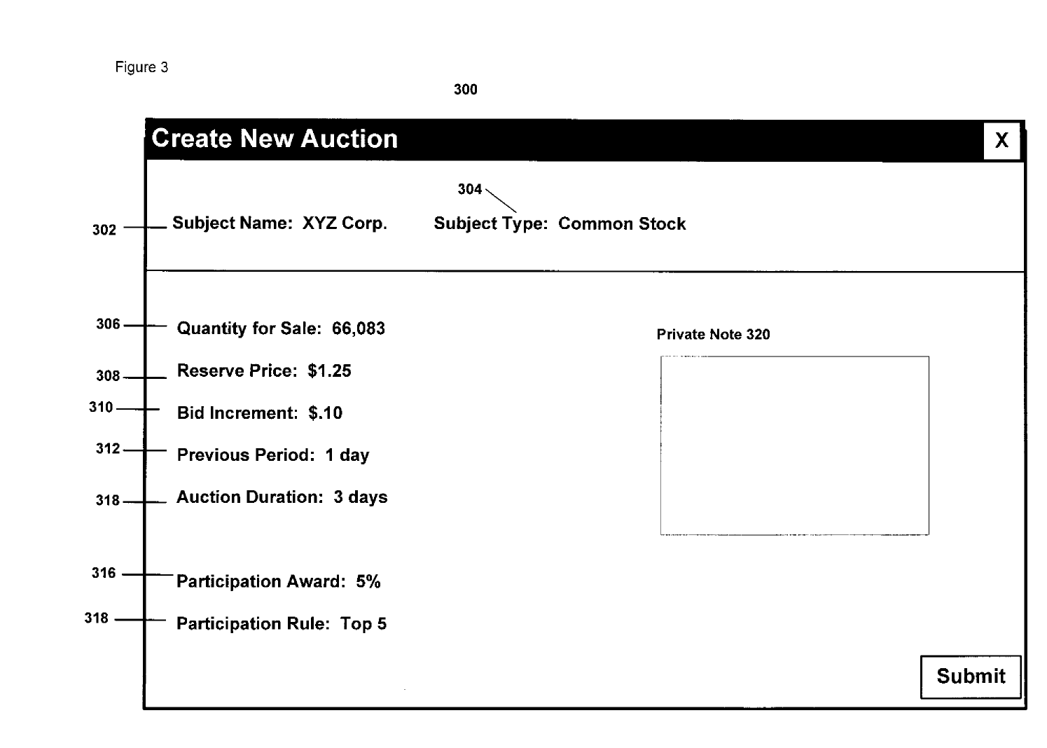

According to an embodiment of the present invention, the Auction System 102 receives a request to initialize an auction via the Internet or other like network using a web-based interface such as, for example, a Form 300. As illustrated in FIG. 3, the exemplary Form 300 is populated by the Seller 104 to gather the auction parameters. In the example illustrated in FIG. 3, the top portion of Form 300 provides for a Subject Name 302 and Subject Type 304. According to the example information populated in the Form 300, the Seller 104 communicates a request for the creation of an auction for the sale of shares of common stock of the XYZ Corp. In addition, the Form 300 provides of a Quantity for Sale 306 field, a Reserve Price 308 field, and a Bid Increment 310 field. As illustrated in FIG. 3, in this example, 66,083 shares of common stock are posted for sale with a reserve price of $1.25 per share and a bid increment of $0.10 a share. According to the auction initiated based on the auction parameters illustrated in FIG. 3, the Seller 104 has specified that all instruments must be purchased by a single bidder. Form 300 also defines a Preview Period 312 and an Auction Duration 314. The Preview Period 312 is an optional parameter that determines the length of time an auction can be reviewed before the auction becomes active and bids are accepted. For example, if the Preview Period 312 is three days and the Auction Duration 314 is six hours, potential bidders may review the auction for three days before the auction becomes active. Once active, bids may be place in the auction for six hours.

Finally, Form 300 allows the Seller 104 to define a Participation Award Parameter 316 and a Participation Rule 318. As illustrated in FIG. 3, the Seller 104 has specified that the Participation Award Parameter 316 is 5% of the winning bid and the Participation Rule 318 defines that the bidders having the five highest bids will share in a participation award. According to the embodiment of the present invention illustrated in FIG. 3, Form 300 also provides the Seller 104 with the ability to add a Private Note 320 along with the auction parameters. The Private Note 320 may be any additional comments the Seller 104 wishes to provide to the Auction System 102. For example, a Seller 104 might include a note stating “Please call me when 5 unique bidders have bid on my auction”.

Following the receipt of the request to initialize an auction, at step 202 of FIG. 2, the Auction Controller Module 112 passes the auction parameters, contained in the request, to the Auction Engine Module 116 to initialize the auction, at step 204. The Auction Engine Module 116 is configured to initialize and manage a plurality of auctions. More specifically, initialization of an auction includes establishing the logic used to manage the auction through its life cycle. This may include creating entries within the Database 118 used to store the auction parameters, bidder information, participation status for engaged bidders, and other information utilized to conduct an auction.

When initializing an auction, the Auction Engine Module 116 analyzes the auction parameters to determine if any issues must be addressed prior to opening the auction for bidding. For example, according to certain embodiments of the present invention, a Third Party Platform 120 may be consulted prior to initializing a requested auction to determine if any regulatory considerations must be resolved prior to initiating an auction. For example, when the subject of an auction is a financial instrument, one or more regulatory institutions may be required to approve the auction prior to initialization. According to certain embodiments of the present invention, a regulatory body might be in charge of an auction but chose to outsource the technology and maintenance of the auction to the Auction System 102. For example, the Federal Reserve could hold a Term Asset-Backed Securities Loan Facility (TALF) auction using the Auction System 102.

Furthermore, involvement of a Third Party Platform 120 may also apply outside the regulatory context. For example, an auction may be conducted on behalf of an issuer of securities, wherein the issuer or issuer's platform is the Third Party Platform 120. In a further embodiment of the present invention, an auction may be part of a bankruptcy proceeding and the platform of the court or trustee may be the Third Party Platform 120.

Once the Auction Engine Module 116 initializes an auction, and the start date of the auction has passed, the auction is considered an ‘active’ auction and the Bidders 106 may place bids with respect to the auction. The auction remains an active auction until a selected end date and/or time has been reached. The Auction Controller Module 112 is configured to receive bids for an auction, at step 206 in FIG. 2. In order to engage in a given auction, potential bidders access the Auction System 102 and may search through all active auctions. According to an embodiment of the present invention, the Bidders 106 may access the Auction System 102 through a web browser and search through all active auctions to identify one or more auctions of interest. The Bidders 106 may then select one of the active auctions and submit a bid. Alternatively, a Bidder 106 may request that the Auction System 102 notify the Bidder 106 wherever an auction is initiated that meets a set of customizable parameters. For example, a Bidder 106 may be interested in acquiring preferred stock in a company with 2-3 million shares outstanding. As a result, the Auction System 102 may notify a Bidder 106 when an auction meeting these requirements is initiated.

Given that the Bidders 106 have the opportunity to receive a portion of a winning bid, there is an incentive to confirm that only legitimate and validated bidders are engaged in an auction. As a result, according to certain embodiments of the present invention, the Bidder 106 may be screened prior to engaging in a given auction to ensure that the bidder is a “verified bidder.” The term “verified bidder” is intended to include, but is not limited to, a bidder authorized by the Auction System 102 to submit a bid in a given auction, following a verification/screening process. During the screening process, a potential bidder is provides the Auction Controller Module 112 with relevant financial information to confirm the bidder possesses adequate capital to realistically engage in a given auction. In addition to capital considerations, other factors, such as, for example, current portfolio holdings and conflicts of interest may be used to determine bidder verification. According to embodiments of the present invention wherein the bidder is verified, the Auction Controller Module 112 may establish the verification of a bidder for a specific auction or the verification of a bidder may be determined with respect to one or more auctions which meet certain criterion (e.g., expected winning bid, regulatory considerations, subject matter). Moreover, in certain embodiments of the present invention, the Auction Monitor 108 may communicate with the Auction Controller Module 112 to facilitate the determination the verification of a bidder. The Auction Monitor 108 may be a module external to the Auction System 102 used to verify a Bidder 106. For example, the Auction Monitor 108 may be a criminal background check service whereby a Bidder 106 is only verified if the Bidder 106 is first approved by the criminal background check system. As a result, in an embodiment of the present invention wherein a Bidder 106 is not verified, the Bidder 106 may be restricted from placing bids in one or more auctions.

Furthermore, given that the expected winning bid (i.e., the amount of the bid that the Auction System 102 estimates will be the winning bid) for an auction may change during the life of an auction, the verification of a bidder may change while an auction is active. For example, a bidder may initially be a verified bidder when an auction for 1,000 shares of common stock begins, based upon the then current expected winning bid is in the range of $25,000-$45,000. However, due to a high demand for the shares of common stock, the updated winning bid may be in the range of $50,000-$75,000. As a result, a bidder that was considered a verified bidder for an auction in the range of $25,000-$45,000, may not be considered a verified bidder for an auction with a winning bid of $50,000-$75,000. The same could be true in an embodiment of the present invention where there is decreased demand for an auction and the winning bid may be trending lower than originally expected. As a result, embodiments of the present invention determine the verification of a bidder periodically during an auction or after the receipt of each bid.

According to the embodiment of the present invention illustrated in FIGS. 1 and 2, the Auction Controller Module 112 receives a bid from the Bidders 106, at step 206. The Auction Controller Module 112 forwards the bid to the Auction Engine Module 116 for processing. The Auction Engine Module 116 first identifies the auction corresponding to the received bid. The Auction Engine Module 116 then determines whether the bid exceeds the current highest bid. Given that a plurality of bids for a given auction may be placed by .numerous bidders simultaneously, the current highest bid may change between the time a bidder submits a bid and the time the bid is processed. As a result, a bidder may place a bid that exceeds the current highest bid at the time of submission but fails to exceed this value at the time of processing. In addition, the Auction Engine Module 116 may determine whether the bid meets an incremental bid requirement specified by the Seller 104. If the incremental bid requirement is not met, or the bid does not exceed the current highest bid, the Auction Engine Module 116 rejects the bid and the Auction Controlled Module 112 communicates to the associated Bidder 106 that the bid has been rejected. Furthermore, the Auction Engine Module 116 may also confirm that the Bidder 106 placing the bid is a verified bidder with respect to the corresponding auction.

Following the confirmation that the received bid exceeds the current highest bid, and meets any applicable incremental bid requirement, the Auction Engine Module 116 updates the current highest bid and determines the one or more participating bidders, at step 208. The Auction Engine Module 116 first updates the current highest bid in response to the received bid. As a result of a change to the current highest bid, the Auction Engine Module 116 updates the participation status of the bidders engaged in the given auction. Accordingly, when the current highest bid is updated, the participation status of another bidder changes from participating to non-participating.

According to an embodiment of the present invention, the Auction Engine Module 116 utilizes the participation rule to update the participation status of one or more bidders, at step 208. As described above, the participation rule is used to determine which bidders are entitled to receive a portion of the winning bid. In an embodiment of the present invention, a Seller 104 may request the use of a “Top 3” participation rule which dictates that the three highest bidders are considered participating bidders. The Auction Engine Module 116 applies the “Top 3” participation rule and sets the participation status of the bidders with the three highest bids to “Participating.” The participation status of any bidder that is not a participating bidder will have their participation status set to “Non-Participating.”

For example, assume an auction has been active for two days and in that time the current highest bid has been updated 25 times. Furthermore assume that at the present time the five highest bids in an auction, wherein the participation rule is Top 3, are as follows.

TABLE 1

| Bidder Name | Bid | Participation Status |
|---|---|---|
| Bidder XYZ | $1,250 | Highest Bidder & |
| | | Participating |
| Bidder GHI | $1,000 | Participating |
| Bidder ABC | $990 | Participating |
| Bidder RST | $950 | Non-Participating |
| Bidder DEF | $900 | Non-Participating |

As shown in Table 1, Bidder XYZ is the current highest bidder and Bidder XYZ, Bidder GHI, and Bidder ABC have the three highest bids. As a result, Bidder XYZ, Bidder GHI, and Bidder ABC each have a participation status of “Participating.” The participation status for Bidder XYZ is “Highest Bidder & Participating” given that Bidder XYZ has the highest bid and the participation rule allows the highest bidder to be a participating bidder. Based on Table 1, if the auction were to close having received no additional bids, Bidder XYZ, Bidder GHI, and Bidder ABC would remain participating bidders and would receive a portion of the participation award. However, assume the Auction Engine Module 116 receives a bid for $1,300 from Bidder UVW. The Auction Engine Module 116 would update the highest bidder and recalibrate the information within Table 1 as illustrated in Table 2.

TABLE 2

| Bidder Name | Bid | Participation Status |
|---|---|---|
| Bidder UVW | $1,300 | Highest Bidder & |
| | | Participating |
| Bidder XZY | $1,250 | Participating |
| Bidder HIJ | $1,000 | Participating |
| Bidder ABC | $990 | Non-Participating |
| Bidder RST | $950 | Non-Participating |
| Bidder DEF | $900 | Non-Participating |

As shown in Table 2, Bidder UVW now holds the current highest bidder. As a result, the participation status of Bidder ABC has changed from “Participating” to “Non-Participating and the participation status of Bidder XYZ has changed from the “Highest Bidder & Participating” to just “Participating.” According to certain embodiments of the present invention, the Auction Engine Module 116 may perform this iterative process of updating the participation status of one or more bidders each time the current highest bidder changes. In an embodiment of the present invention wherein the auction is a forward bid auction (i.e., every bid needs to be higher than the current highest bid), it can be assumed that all of the bids in Table 1 and Table 2 were at one point the highest bid. However, in a sealed bid auction (i.e., bidders place bids without knowledge of the current highest bid) each bid may not necessarily have been the highest bid at one point during the auction.

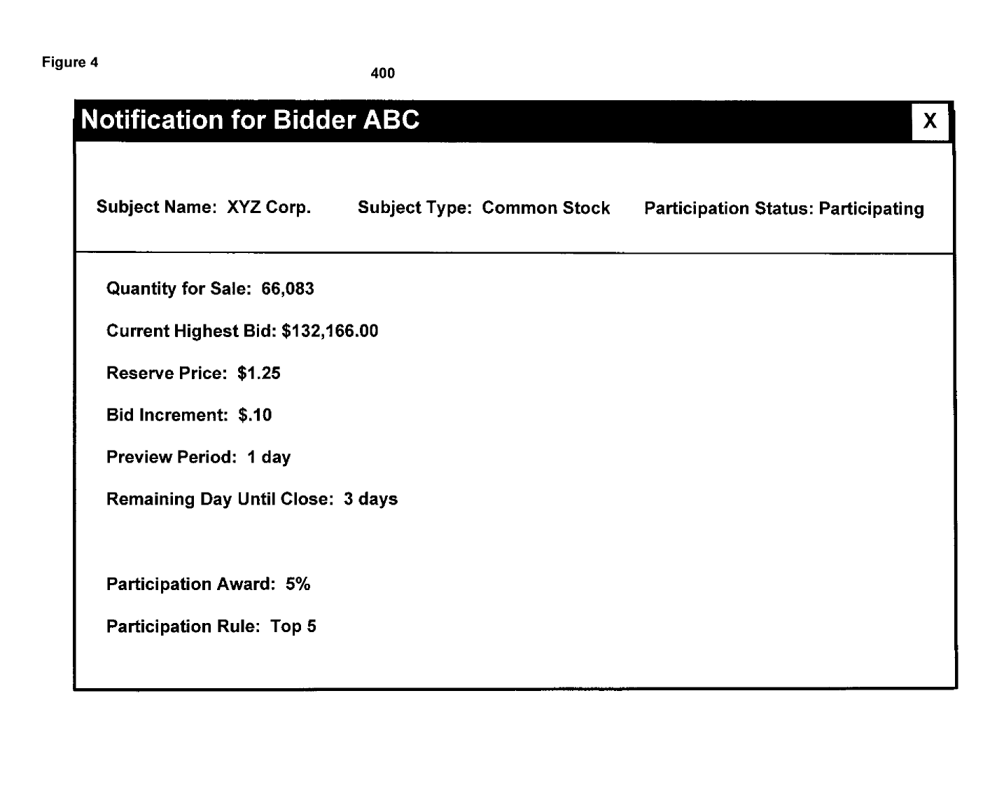

According to alternative embodiments of the present invention, the Auction System 102 may notify one or more of the Bidders 106 as to his or her participation status following the updating the participation status of one or more bidders, at step 208. Such notifications inform the Bidders 106 if he or she is currently a participating bidder or the highest bidder. A Seller 104 may request notifications to be sent to one or more bidders as a way of generating interest in an auction. As a result, the Seller 104 can request notifications be sent following the receipt of every bid or periodically during the term of an auction. FIG. 4, illustrates an example of a notification that may be sent to one or more of the Bidders 106. Such notification may be transmitted to a Bidder 106 via email or other electronic communication medium. The Seller 104 or the Bidders 106 may customize the information included in such a notification.

Following the step 208 of updating the participation status of one or more bidders, the Auction Controller Module 112, waits for additional bids at step 210. According to embodiments of the present invention, the Bidders 106 may continue to place bids for a given auction while the auction is active. Upon receipt by the Auction Controller Module 112 of a new bid, at step 210, the bid is forwarded to the Auction Engine Module 116 to update the participation status of the one or more bidders involved in the auction, at step 208. In the event that no additional bids are received, process 200 continues to step 212, wherein the Auction Engine Module 116 establishes the winning bid.

According to embodiments of the present invention, the highest bid at the time the auction closes is considered the winning bid. An exemplary implementation of an embodiment of the present invention is illustrated Table 3. Table 3 show the top 10 bids at the time an auction closes, with Bidder G, having the winning bid of $45,000. In the example provided in Table 3, the participation rule is “Top 5.” As a result, the top 5 bidders will be considered participating bidders. The Auction Controller Module 112 notify the winning bidder (Bidder G) that he or she has the highest bid and won the auction.

TABLE 3

| Bidder Name | Bid | Participation Status |
|---|---|---|
| Bidder G | $45,000 | Winning Bid & |
| | | Participating |
| Bidder A | $44,000 | Participating |
| Bidder H | $43,000 | Participating |
| Bidder B | $42,000 | Participating |
| Bidder E | $41,000 | Participating |
| Bidder F | $40,000 | Non-Participating |
| Bidder C | $39,000 | Non-Participating |
| Bidder D | $38,000 | Non-Participating |
| Bidder I | $37,000 | Non-Participating |
| Bidder J | $36,000 | Non-Participating |

Following the determination of the winning bid, at step 212, the Auction Engine Module 114 calculates the participation award, at step 214. The participation award is calculated based on the participation award parameter defined by the Seller 104. The participation award parameter defines the portion of the winning bid that is allocated to the one or more participating bidders. For example, assume the Seller 104 for the auction reflected in Table 3 defines a participation award parameter to be 5%. Therefore, the participation award would be 5% of $45,000, or $2,250. As described above, the Seller 102 may define the participation award parameter as they see fit for a given auction. Given that the Bidders 106 are aware of the participation award parameter prior to bidding on a given auction, the Seller 104 may strike a balance between providing an adequate participation award to entice bidding without significantly diminishing the profits associated with the sale.

According to certain embodiments of the present invention, the Account Controller Module 114 may maintain an account for the Seller 104 and/or the Bidders 106. Proceeds from an auction may be deposited into such an account maintained for a Seller 104. Furthermore, a participation award may be deposited into the account maintained for a Bidder 106. Moreover, funds in such an account may be applied to an future transaction in the event that a Bidder 106 wins an subsequent auction.

According to certain embodiments of the present invention, following the calculation of the participation award, the Account Controller Module 114 collects the winning bid from the winning bidder, at step 216. In an embodiment of the present invention wherein the Account Controller Module 114 maintains an account for the winning bidder, the Account Controller Module 114 may draw down the internally maintained account in the amount of the winning bid. Alternatively, the Account Controller Module 114 may receive the fund in support of the winning bid directly from the winning bidder or from a third party bank. According to the embodiment of the present invention in FIG. 2, the winning bid is collected after calculation of the participation award, however, these steps 216 and 214 may occur in reverse order or simultaneously.

Following the collection of the winning bid, the Account Controller Module 114 allocates the participation award to the participating bidders. The Account Controller Module 114 utilizes the participation rule to determine which bidders are considered participating bidders. For example, if the Seller 104 selects a participation rule of “Top 5,” the bidders with the five highest bids are considered participating bidders, as shown in Table 3. Given that the participation status is updated periodically during the life of the auction, determining the participating bidders may be accomplished by consulting the current participation status of one or more of the Bidders 106. As such, the participation award may be allocated equally among the participating bidders. In alternative embodiments of the present invention, the participation rule may dictate that the participation award be unevenly allocated between the participating bidders.

Allocating the participation award may include, but is not limited to, determining the portion of the participation award for each participating bidder, updating an account maintained by the Account Controller Module 114 to reflect a participating bidder's receipt of a portion of the participation award, transferring a portion of a participation award to one or more of the participating bidders, or transferring a portion of the participation award directly to one or more of the participating bidders. According to certain embodiments of the present invention, a bidder may utilize the Auction System 102 to bid on numerous auctions. As a result, the Account Controller Module 114 may maintain an account for a bidder to which participation awards may be distributed, and any funds associated with a winning bid may be drawn against the account. In addition, if the bidder acts as a seller is a different transaction/auction, any gains from a sale could also, be distributed to the account maintained by the Account Controller Module 114. Alternatively, the participation award may be paid directly to a bidder, or transferred to a bidder's third party account following the close of each auction. According to certain embodiments of the present invention, the Settlement Module may assist the Account Controller Module 114 when allocating the participation award.

The Settlement Module may include, but is not limited to, a system that may interface with the Account Controller Module 114 to manage account allocation and directly deposit funds into the account of a Bidder 106 or Seller 104, whether the account is managed by the Auction System 102 or a third party. For example, upon the completion of the auction, the Seller 104 may receive the proceeds deposited directly into their account(s) following their settlement instructions. The Seller 104 may want half of the proceeds deposited in one account and the other half in another account. Upon completion of the auction, participating bidders may also have his or her share of the participation award deposited into an account. The settlement module therefore stores the settlement instructions for each user, and may be integrated into the Auction System 102.

Based on the example described above and illustrated in Table 3, wherein a Seller 104 has established an auction wherein the participation award parameter is 5% and the participation rule is “Top 5” bidders, the participation award of $2,250 is distributed among the top 5 bidders. As a result, Bidder G, Bidder A, Bidder H, Bidder B, and Bidder E each receive $810. In an alternative embodiment of the present invention, the Seller 104 may elect to award the top 5 bidders an unequal portion of the participation award. For example, Bidder G may receive $1,000, Bidder A may receive $500, Bidder H may receive $400, Bidder B may receive $250, and Bidder E may receive $100. An uneven distribution of the participation award may incentivize bidders to become more engaged in a given auction by rewarding bidders that have higher non-winning bids.

According to certain embodiments of the present invention, the Account Controller Module 114 distributes the remaining profits from the winning bid to the Seller 104, at step 220. In addition to removing the participation award from the winning bid, the Account Controller Module 114 may remove any fees associated with conducting the auction. These fees could include, but are not limited to, a percentage of the Winning bid, a fixed fee, or a graduate percentage of the winning bid. Following the removal from the winning bid of the participation fee and any additional fees, the remaining portion of the winning bid is provided to the Seller 104. As with the distribution of the participation fee described above, the remaining portion of the winning bid could be deposited in an account maintained by the Auction System 102, paid directly to the Seller 104, or transferred to the Seller's third party account.

Embodiments of the present invention may include a web interface wherein bidders and sellers may monitor the progress and engage in one or more auctions. The interface may provide information regarding an auction, including, for example, current highest bid, duration of the auction, and auction parameters. According to certain embodiments of the present invention, the web interface may also provide the participation status for one or more bidders engaged in an auction.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

1. A computer implemented method for allocating a portion of a winning bid for an auction to one or more participating bidders, comprising:
receiving, by a computer, a request to initialize the auction from a seller, wherein the request comprises a plurality of auction parameters comprising:
a participation award parameter, and
a participation rule;
initializing, by the computer, the auction based on the request;
receiving, by the computer, one or more bids from a plurality of bidders;
determining, by the computer, the one or more participating bidders from the plurality of bidders based on the participation rule;
establishing, by the computer, a winning bid based on the one or more bids from the plurality of bidders;
calculating, by the computer, a participation award based on the participation award parameter and the winning bid; and
allocating, by the computer, a portion of the participation award to each of the one or more participating bidders.

2. The computer implemented method of claim 1, wherein the step of determining the one or more participating bidders occurs following receipt of each of the one or more bids.

3. The computer implemented method of claim 1, wherein each of the plurality of bidders has a participation status of either a participating bidder, a non-participating bidder, or a highest bidder.

4. The computer implemented method of claim 3, wherein the participation status of one of the plurality of bidders is changed following the receipt of a new bid.

5. The computer implemented method of claim 4, wherein the one of the plurality of bidders is notified of the change in participation status.

6. A system for allocating a portion of a winning bid for an auction to one or more participating bidders, comprising:
an auction controller module configured to:
receive a request to initialize the auction from a seller, wherein the request comprises a plurality of auction parameters comprising:
a participation award parameter, and
a participation rule, and
receive one or more bids from a plurality of bidders;
an auction engine module configured to:
initialize the auction based on the request, determine the one or more participating bidders from the plurality of bidders based on the participation rule,
establish a winning bid based on the one or more bids, and
calculate a participation award based on the participation award parameter and the winning bid; and
an account allocation module configured to allocate a portion of the participation award to each of the one or more participating bidders.

7. The system of claim 6, wherein the auction engine module is further configured to determine the one or more participating bidders from the plurality of bidders following receipt of each of the one or more bids.

8. The system of claim 7, wherein each of the plurality of bidders has a participation status of either a participating bidder, a non-participating bidder, or a highest bidder.

9. The system of claim 8, wherein the auction engine module is further configured to change the participation status of one of the plurality of bidders following the receipt of a new bid.

10. The system of claim 9, wherein the auction controller module is further configured to notify the one of the plurality of bidders of the change in participation status.

11. A computer implemented method for allocating a portion of a winning bid for an auction to one or more participating bidders, comprising:
receiving one or more bids from one or more participating bidders;
determining the winning bid for the auction; and
allocating a portion of the winning bid to at least one of the one or more participating bidders.
